(19) United States
(12) Patent Application Publication
(10) Pub. No.: US 2011/0050750 A1
(43) Pub. Date: Mar. 3, 2011

(54) LCD DRIVING METHOD AND DEVICE

(75) Inventor: Haiyu ZHAO, Beijing (CN)

(73) Assignee: BEIJING BOE OPTOELECTRONICS TECHNOLOGY CO., LTD., Beijing (CN)

(21) Appl. No.: 12/858,745

(22) Filed: Aug. 18, 2010

(30) Foreign Application Priority Data
Aug. 28, 2009 (CN) 200910091910.4

(51) Int. Cl. G09G 5/00

(52) U.S. Cl. 345/690; 345/87

(57) ABSTRACT

A LCD driving method and device for correcting LCD image sticking. The method of correcting image sticking in a LCD comprises steps of: determining whether any change occurs to a first image displayed by refreshing on a LCD in a predetermined time period; and controlling the LCD to refresh and display, after the predetermined time period, a second image that is different from the first image, if it is determined that no change occurs to the first image displayed by refreshing on the LCD in the predetermined time period, so as to correct image sticking caused by displaying the first image for a long period of time.

### BACKGROUND

The embodiments of the invention relates to a liquid crystal display (LCD) driving method and a LCD driving device.

Thin film transistor liquid crystal displays (TFT-LCDs), mainstream products in the display market, are widely used in televisions and computer displays. A LCD panel is the main component of a TFT-LCD and comprises a color filter substrate, a TFT array substrate, liquid crystal, sealant, orientation films, and etc.

A LCD often has defects, such as tailing, slow response, and image sticking, among which image sticking has a significant adverse effect on display quality of the LCD. FIG. 1 is a schematic view showing a first image displayed on a TFT-LCD; FIG. 2 is a schematic view showing a second image to be displayed on the TFT-LCD after the first image has been displayed for a long period of time, and FIG. 3 is a schematic view showing the second image actually displayed on the TFT-LCD.

Image sticking refers to the following phenomenon: after a TFT-LCD displays a first image, such as the black and white chessboard, as shown in FIG. 1 for a long period of time, when the image is to be changed to a second image, such as the image of grey level 127, as shown in FIG. 2, the image of the chessboard of the first image as shown in FIG. 1 will still remain to an extent, as illustrated in FIG. 3. When an image has been loaded and displayed for a long period of time, in the LCD panel, ions will move along the direction of the electrical field towards the upper or lower substrate, and they congregate on the orientation films and produce an internal electrical field. When the image is changed, the ions congregating on the orientation films can not leave the layer right away, thus the existent RDCV (remaining direct current voltage) renders the original image retained on the LCD to an extent.

Image sticking has a significant adverse effect on the display quality of a TFT-LCD, and thus has been the research focus of TFT-LCD manufacturing companies. The conventional methods correct image sticking from four aspects, including: pixel design, array structure, material and processing for liquid crystal, and driving method. One important approach is to reduce the ion concentration in a LCD panel and thus correct image sticking via material selection for a TFT-LCD. Nevertheless, on one hand, the ion concentration in the material of liquid crystal and the orientation film is already very low, and thus it is difficult to further decrease the ion concentration from this point; on the other hand, because the material of liquid crystal is a mixture of liquid crystal of many sorts, it is hardly possible to analyze mutual impact among them, as well as the mutual impact between various components of the liquid crystal material and the orientation film or sealant, which renders it especially difficult to further correct image sticking via analysis.

### SUMMARY

In one respect, an embodiments of the invention provides a method of correcting image sticking in a liquid crystal display (LCD), comprising steps of: determining whether any change occurs to a first image displayed by refreshing on a LCD in a predetermined time period; and controlling the LCD to refresh to display, after the predetermined time period, a second image that is different from the first image, if it is determined that no change occurs to the first image displayed by refreshing on the LCD in the predetermined time period, so as to correct image sticking caused by displaying the first image for a long period of time.

In another respect, an embodiment of the invention provides a liquid crystal display (LCD) driving device, comprising: a gate electrode driving circuit; a source electrode driving circuit; a determining module, for determining, based on feeding information, whether any change occurs to a first image displayed by refreshing on a LCD in a predetermined time period; a control module, connected to the gate electrode driving circuit, the source electrode driving circuit, and the output end of the determining module, for controlling the LCD to refresh to display, after the predetermined time period, a second image that is different from the first image through operation of the gate electrode driving circuit and the source electrode driving circuit, if it is determined that no change occurs to the first image displayed by refreshing on the LCD in the predetermined time period, so as to correct image sticking caused by displaying the first image for a long period of time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a schematic view showing a first image displayed in a TFT-LCD;

FIG. 2 is a schematic view showing a second image to be displayed in the TFT-LCD;

FIG. 3 is a schematic view showing the second image actually displayed in the TFT-LCD;

FIG. 4 is a schematic view showing a method of correcting image sticking in a LCD according to a second embodiment of the invention;

FIG. 5 shows the change of RDCV of black squares of FIG. 1 vs. time;

FIG. 6 is a displaying image inverse to the image displayed in FIG. 1 according to an embodiment of the invention;

FIG. 7 is a schematic view of a first image according to one embodiment of the invention;

FIG. 8 shows a second image inverse to the first image as shown in FIG. 7 according to one embodiment of the invention;

FIG. 9 is a schematic view showing the configuration of the LCD driving device according to a third embodiment of the invention; and

FIG. 10 is a schematic view showing the configuration of the LCD driving device according to a fourth embodiment of the invention.

### DETAILED DESCRIPTION

Hereinafter, detailed description of the embodiments will be given with references to the accompanying drawings.

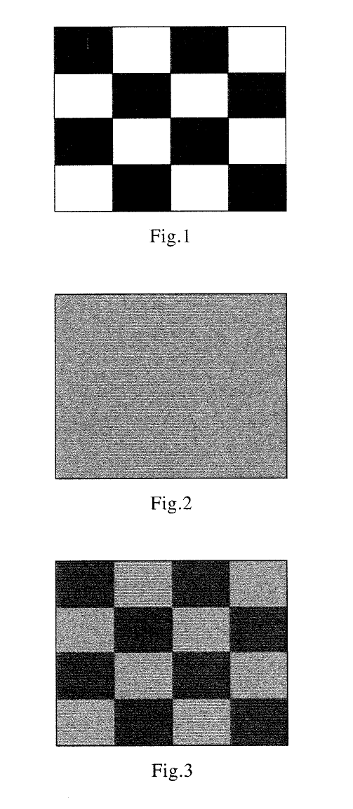

Usually, the magnitude of RDCV (remaining direct current voltage) can be used to indicate the seriousness of image sticking; the larger the RDCV is, the more serious the image sticking is. Regarding the white squares shown in FIG. 1, their voltage asymmetry is small and can be treated as zero voltage asymmetry, and thus RDCV does not occur in the course of time; while black squares shown in FIG. 1 have significant voltage asymmetry, and thus significant RDCV occurs in the course of time. FIG. 5 shows the change of RDCV of black squares shown in FIG. 1 vs. time. A LCD panel displays an image as shown in FIG. 1 in time period T1 and displays an image as shown in FIG. 2 after the time period T1. As shown in FIG. 5, RDCV decreases after the time period T1, time period T2 is a fast-decreasing stage, and time period T3 is a slow-decreasing stage.

The time period T1 is approximately 2000˜6000s, and the time period T2 is about 2˜30s. The increasing rate of RDCV in the period T1 is much smaller than the decreasing rate in the period T2. As can be seen from FIG. 5, RDCV can be reduced by way of inserting a particular image (the second image) into the image regularly displayed (the first image). The inserted second image can be any image that is different from the first image, preferably that is inverse to the first image. The term “inverse” means: regarding each sub-pixel of the second image, the sum of its grey level and that of the corresponding sub-pixel of the first image falls into a given range; for example, in the case where the displaying grey level of a sub-pixel of the second image is G2 and that of the corresponding sub-pixel of the first image is G1, G1+G2=250˜260.

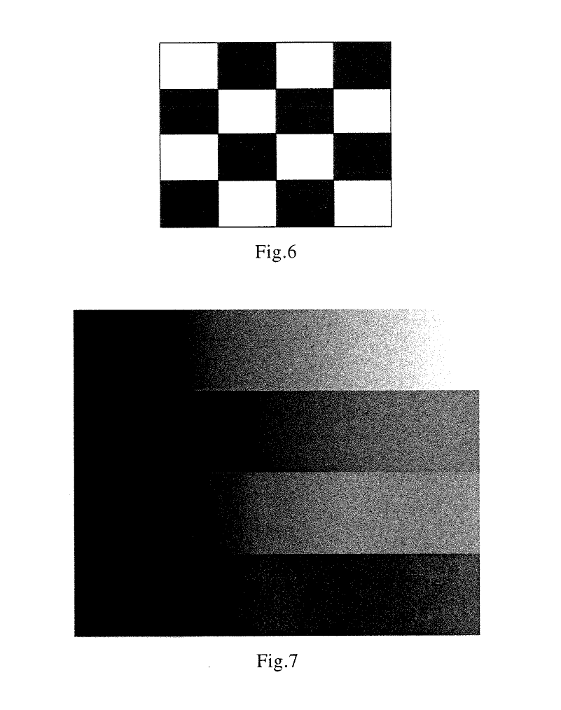

For instance, for a LCD with a refreshing rate of 60 Hz, it is feasible to insert a particular image every one second. Take the familiar image sticking evaluation image shown in FIG. 1 as an example, FIG. 6 is a displaying image inverse to the displaying image shown in FIG. 1 according to the embodiments of the invention. In a conventional driving method, 60 frames of image within 1 second (s) are all identical to FIG. 1. Nevertheless, the last frame of image identical to FIG. 1 within 1 s is substituted by the image shown in FIG. 6 according to one embodiment of the invention. Because the decreasing rate of RDCV is much larger than the increasing rate, the inserted particular image can render most RDCV accumulated within is released swiftly. Meanwhile, for human eyes, the inserted image that lasts for only 1/60 s is unnoticeable.

Here, the reason for not straightly inserting a grey image of grey level 255 is that, in addition to reduce RDCV, having approximately equal RDCVs in black and white squares is also concerned. Regarding the black squares in FIG. 1, the RDCV produced by the previously displayed 59 frames of the image can be reduced by 80%˜95% by inserting 1 frame of the image shown in FIG. 6, and there still remains 5%˜20% of the RDCV that requires a slow releasing. The black squares of FIG. 6 function to produce some RDCV in the white squares, where RDCV hardly occurs; i.e., after 59 frames of the image as shown in FIGS. 1 and 1 frame of the image as shown in FIG. 6, the RDCVs in black and white squares become approximately equal, which makes it possible to correct image sticking even better.

For another example, FIG. 7 is the schematic view of the first image according to one embodiment of the invention, and FIG. 8 shows the second image inverse to the first image as shown in FIG. 7 according to one embodiment of the invention. For a LCD panel with a refreshing rate of 60 Hz, in the case the initial 59 frames within 1 s all display the first image, a particular image, the second image as shown in FIG. 8, is inserted as the last frame of the 1 s, i.e. the 60^{th} frame. This method applies to images of colors as well, as long as the sum of the grey level of each sub-pixel of the inserted second image and that of the corresponding sub-pixel of the first image is kept in a given range. For example, in the case where the displaying grey level of a sub-pixel of the second image is G2 and that of the corresponding sub-pixel of the first image is G1, G1+G2=250˜260.

The first embodiment of the invention provides a method of correcting image sticking of a LCD. The method comprises the following steps.

Step 401, determining whether any change occurs to a first image displayed by refreshing on a LCD in a predetermined time period.

Displaying each image on a LCD requires a given refreshing rate, and the refreshing rate can generally be 60 Hz for a LCD.

Step 402, controlling the LCD to refresh to display, after the predetermined time period, a second image that is different from the first image, if it is determined that no change occurs to the first image displayed by refreshing on the LCD in the predetermined time period, so as to reduce image sticking caused by displaying the first image for a long period of time.

In step 402, the sum of the grey level of each sub-pixel of the second image and that of the corresponding sub-pixel of the first image can be within the range of 250˜260, preferably equal to 255.

The method of correcting LCD image sticking according to the embodiment can reduce RDCV caused by displaying the first image for a long period of time and thus corrects image sticking in a LCD and improves image displaying quality of the LCD, by way of inserting a second image that is different from the first image after the first image has been displayed for a long period of time.

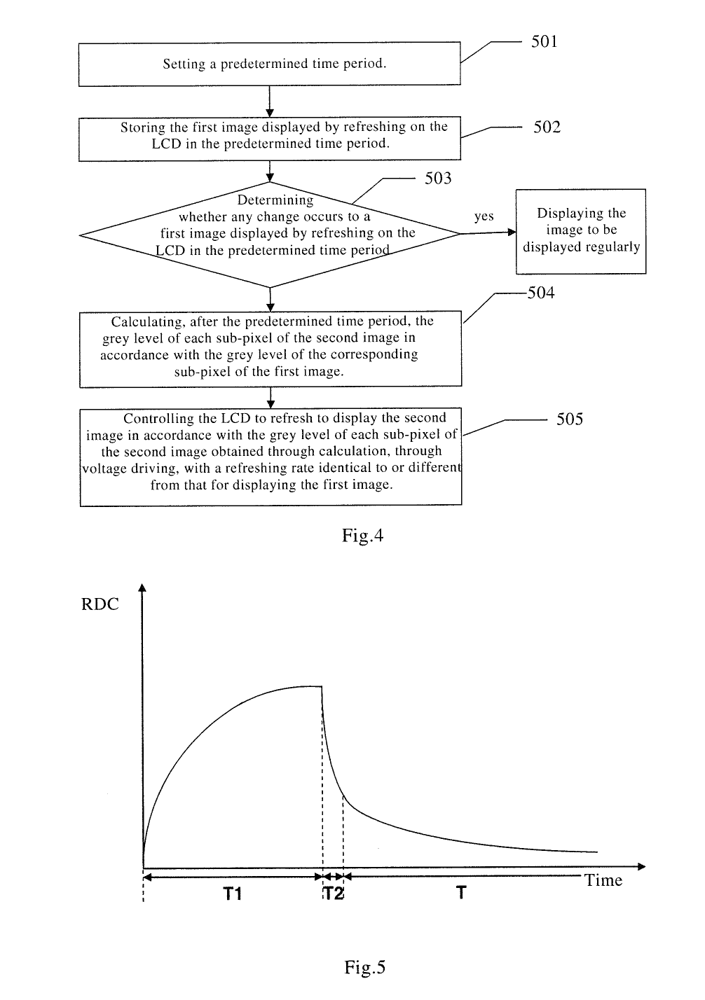

FIG. 4 is the schematic view showing the method of correcting image sticking in a LCD according to a second embodiment of the invention. As shown in FIG. 4, the method comprises the following steps:

Step 501, setting a predetermined time period.

The predetermined time period can usually be set within the range of 0.5˜1.5 s; but it is not specifically limited, it can be any time during which image sticking occurs after displaying the same image for a long period of time. In this embodiment, the predetermined time period can be 59/60 s, and the corresponding image refreshing rate can be 60 Hz.

Step 502, storing the first image displayed by refreshing on the LCD in the predetermined time period.

Step 503, determining whether any change occurs to a first image displayed by refreshing on the LCD in the predetermined time period. If some change does occur, i.e., the displayed image is not the same one in the predetermined time period, it means the LCD did not display the same image for a long period of time and hence there will be almost no RDCV, the image to be displayed can be displayed regularly; otherwise step 504 is executed.

Step 504, calculating, after the predetermined time period, the grey level of each sub-pixel of the second image in accordance with the grey level of the corresponding sub-pixel of the first image.

In the step, during calculation of the grey level of each sub-pixel of the second image, the sum of the grey level of each sub-pixel of the second image and that of the corresponding sub-pixel of the first image can be preferably set as 255.

Step 505, controlling the LCD to refresh to display the second image in accordance with the grey level of each sub-pixel of the second image obtained through calculation, through voltage driving, with a refreshing rate identical to or different from that for displaying the first image. The second image can be refreshed to display once or more during displaying.

In step 505, the refreshing rate and time for the second image can be chosen by a selecting circuit, the refreshing rate of the second image can be different from that of the first image and the second image can be refreshed to display once or more, as long as the time of displaying the second image on the LCD is shorter than the shortest visual persistence time of human eyes. For example, in the case where the refreshing rate for the first image is set as 60 Hz, the predetermined time period can be set as 59/60 s, during which the first image will be displayed by refreshing for 59 times (here, for sake of convenience, loading the image is treated as the first time of refreshing) with a displaying interval of 1/60 s. The refreshing rate of the second image can be set identical to that of the first image, i.e., 60 Hz, and the second image can be refreshed once (i.e., loading the second image is treated as one refreshing for sake of convenience); in such a case, the second image is displayed for a period of 1/60 s, shorter than the shortest visual persistence time of human eyes (0.05 s˜0.2 s). The refreshing rate of the second image can also be set different from that of the first image, e.g., 100 Hz, and the second image can be refreshed twice; in such a case, the second image is displayed for a period of 0.02 s, still shorter than the shortest visual persistence time of human eyes (0.05 s˜0.2 s).

The method of correcting LCD image sticking according to this embodiment can reduce RDCV caused by displaying the first image for a long period of time and thus corrects image sticking in a LCD and improves image displaying quality of the LCD, by way of inserting a second image that is different from the first image after the first image has been displayed for a long period time.

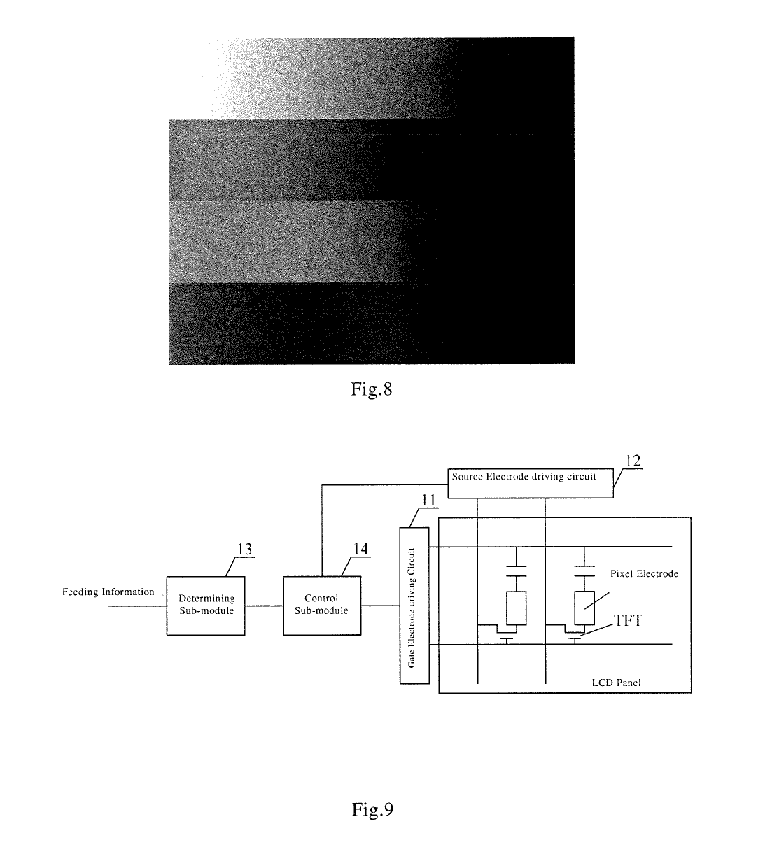

FIG. 9 is the schematic view showing the configuration of the LCD driving device according to a third embodiment of the invention. As shown in FIG. 9, the driving device includes: a gate electrode driving circuit 11; a source electrode driving circuit 12; a determining module 13, for determining, in accordance with feeding information, whether any change occurs to the first image displayed by refreshing on a LCD in a predetermined time period; a control module 14 connected to the gate electrode driving circuit 11, the source electrode driving circuit 12, and the output end of the determining module 13, for controlling the LCD to display by refreshing, after the predetermined time period, a second image that is different from the first image through operation of the gate electrode driving device 11 and the source electrode driving device 12, if it is determined that no change occurs to the first image displayed by refreshing on the LCD in the predetermined time period, so as to correct image sticking caused by displaying the first image for a long period of time. The sum of the grey level of each sub-pixel of the second image and that of the corresponding sub-pixel of the first image falls into the range of 250˜260.

The LCD driving device according to this embodiment can reduce RDCV caused by displaying the first image for a long period of time and thus corrects image sticking in a LCD and improves image displaying quality of the LCD, by way of inserting a second image that is different from the first image after the first image has been displayed for a long period of time.

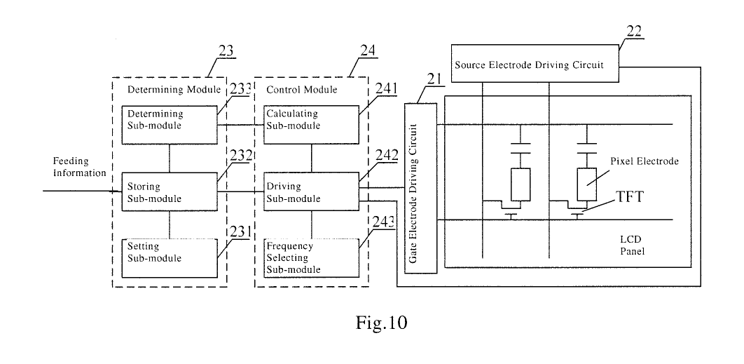

FIG. 10 is the schematic view showing the configuration of the LCD driving device according to a fourth embodiment of the invention. As shown in FIG. 10, the driving device includes: a gate electrode driving circuit 21; a source electrode driving circuit 22; a determining module 23, for determining, based on feeding information, whether any change occurs to a first image displayed by refreshing on the LCD in a predetermined time period; a control module 24 connected to the gate electrode driving circuit 21, the source electrode driving circuit 22, and the output end of the determining module 23, for refreshing to display, after the predetermined time period, a second image that is different from the first image through operation of the gate electrode driving device 21 and the source electrode driving device 22, if it is determined that no change occurs to the first image displayed by refreshing on the LCD in the predetermined time period, so as to correct image sticking caused by displaying the first image for a long period of time.

An example of the determining module 23 can comprise: a setting sub-module 231, a storing sub-module 232, and a determining sub-module 233. The setting sub-module 231 is employed to set the predetermined time period; the storing sub-module 232, receiving feeding information and connected to the setting sub-module 231, is employed to store the first image displayed in the predetermined time period; the determining sub-module 233, connected to the storing sub-module 232, is employed to determine, based on the first image stored by the storing sub-module 232 and displayed in the predetermined time period, whether changes occur to the first image displayed by refreshing on the LCD in the predetermined time period.

An example of the control module 24 can comprise: a calculating sub-module 241 and a driving sub-module 242. The calculating sub-module 241 is employed to calculate, after the predetermined time period, the grey level of each sub-pixel of the second image in accordance with the grey level of each sub-pixel of the first image; the sum of the grey level of each sub-pixel of the second image and that of the corresponding sub-pixel of the first image is preferably 255. The driving sub-module 242 is employed to control the LCD to refresh to display the second image in accordance with the grey level of each sub-pixel of the second image calculated with the calculating sub-module 241, through voltage driving by the gate electrode driving circuit and the source electrode driving circuit, and with a refreshing rate equal to or different from that for refreshing to display the second image; the second image can be refreshed once or more. The time the LCD refreshes and displays the second image is shorter than the shortest visual persistence time of human eyes.

In addition, the control module 24 can further includes: a frequency selection sub-module 243, which, connected to the driving sub-module 242, is employed to transmit, after the predetermined time period, the refreshing rate for refreshing to display the second image to the driving sub-module 242.

The LCD driving device according to this embodiment can reduce RDCV caused by displaying the first image for a long period of time and thus corrects image sticking in a LCD and improves image displaying quality of the LCD, by way of inserting a second image that is different from the first image after the first image has been displayed for a long period of time.

Lastly, the aforementioned embodiments are employed to describe, not to limit, the invention. Notwithstanding that a detailed description is given with references to the embodiments as above, as one of ordinary skill in the art understands, the technique embodied in the above embodiments can be modified, or some technical features can be substituted with the equivalents; such modifications or substitutions do not deviate the nature of the technique from the spirit and scope of the technique embodied in the embodiments according to the invention.

What is claimed is:

1. A method of correcting image sticking in a liquid crystal display (LCD), comprising steps of:
determining whether any change occurs to a first image displayed by refreshing on a LCD in a predetermined time period; and
controlling the LCD to refresh to display, after the predetermined time period, a second image that is different from the first image, if it is determined that no change occurs to the first image displayed by refreshing on the LCD in the predetermined time period, so as to correct image sticking caused by displaying the first image for a long period of time.

2. The method of correcting image sticking in a LCD according to claim 1, wherein the sum of the grey level of each sub-pixel of the second image and that of the corresponding sub-pixel of the first image falls into the range of 250˜260.

3. The method of correcting image sticking in a LCD according to claim 1, wherein the step of controlling the LCD to refresh to display, after the predetermined time period, the second image specifically comprises:
calculating, after the predetermined time period, the grey level of each sub-pixel of the second image in accordance with the grey level of the corresponding sub-pixel of the first image; and
controlling the LCD to refresh to display the second image in accordance with the grey level of each sub-pixel of the second image obtained through the calculating,
wherein the time period for the LCD to refresh to display the second image is shorter than the shortest visual persistence time of human eyes.

4. The method of correcting image sticking in a LCD according to claim 1, wherein when the LCD refresh to display the second image, a refreshing rate that is different from the refreshing rate for displaying by refreshing the first image is employed.

5. The method of correcting image sticking in a LCD according to claim 1, wherein when the LCD refresh to display the second image, a refreshing rate that is identical to the refreshing rate for displaying by refreshing the first image is employed.

6. The method of correcting image sticking in a LCD according to claim 1, wherein before determining whether any change occurs to the first image displayed by refreshing on the LCD, the method further includes the step of: storing the first image displayed by refreshing on the LCD in the predetermined time period.

7. A liquid crystal display (LCD) driving device, comprising:
a gate electrode driving circuit;
a source electrode driving circuit;
a determining module, for determining, based on feeding information, whether any change occurs to a first image displayed by refreshing on a LCD in a predetermined time period;
a control module, connected to the gate electrode driving circuit, the source electrode driving circuit, and the output end of the determining module, for controlling the LCD to refresh to display, after the predetermined time period, a second image that is different from the first image through operation of the gate electrode driving circuit and the source electrode driving circuit, if it is determined that no change occurs to the first image displayed by refreshing on the LCD in the predetermined time period, so as to correct image sticking caused by displaying the first image for a long period of time.

8. The LCD driving device according to claim 7, wherein the sum of the grey level of each sub-pixel of the second image and that of the corresponding sub-pixel of the first image falls into the range of 250˜260.

9. The LCD driving device according to claim 7, wherein the determining module comprises:
a setting sub-module, for setting the predetermined time period;
a storing sub-module receiving the feeding information and connected to the setting sub-module, for storing the first image displayed in the predetermined time period; and
a determining sub-module connected to the storing sub-module, for determining, based on the first image stored by the storing sub-module and displayed in the predetermined time period, whether changes occur to the first image displayed by refreshing on the LCD in the predetermined time period.

10. The LCD driving device according to claim 7, wherein the control module comprises:
a calculating sub-module, for calculating, after the predetermined time period, the grey level of each sub-pixel of the second image in accordance with the grey level of each sub-pixel of the first image; and
a driving sub-module, for controlling the LCD to refresh to display the second image, in accordance with the grey level of each sub-pixel of the second image calculated with the calculating sub-module, through voltage driving by the gate electrode driving circuit and the source electrode driving circuit,
wherein the time period for the LCD to refresh to display the second image is shorter than the shortest visual persistence time of human eyes.

11. The LCD driving device according to claim 10, wherein the refreshing rate employed by the driving sub-module to display the second image is different from that for the first image.

12. The LCD driving device according to claim 9, wherein the control module includes:
calculating sub-module, for calculating, after the predetermined time period, the grey level of each sub-pixel of the second image in accordance with the grey level of each sub-pixel of the first image; and
a driving sub-module, for controlling the LCD to refresh to display the second image, in accordance with the grey level of each sub-pixel of the second image calculated with the calculating sub-module, through voltage driving by the gate electrode driving circuit and the source electrode driving circuit,
wherein the time period for the LCD to refresh to display the second image is shorter than the shortest visual persistence time of human eyes.

13. The LCD driving device according to claim 12, wherein the refreshing rate employed by the driving sub-module to display the second image is different from that for the first image.

14. The LCD driving device according to claim 10, wherein the control module further includes:
a frequency selection sub-module connected to the driving sub-module, for transmitting, after the predetermined time period, a refreshing rate for refreshing to display the second image to the driving sub-module.

15. The LCD driving device according to claim 12, wherein the control module further includes:
a frequency selection sub-module connected to the driving sub-module, for transmitting, after the predetermined time period, a refreshing rate for refresh to display the second image to the driving sub-module.
